(19) United States
(12) Patent Application Publication
(10) Pub. No.: US 2009/0077745 A1
(43) Pub. Date: Mar. 26, 2009

(54) Waterproof bedspread for hospital bed

(76) Inventor: Su Jen Chou, Changhua Hsien (TW)

Correspondence Address: CHARLES E. BAXLEY, ESQUIRE, 90 JOHN STREET, SUITE 309, NEW YORK, NY, 10038, US

(21) Appl. No.: 11/903,886

(22) Filed: Sep. 25, 2007

(51) Int. Cl. A47G 9/00; A47C 31/00; A61G 7/047

(52) U.S. Cl. 5/484; 5/658; 5/606

(57) ABSTRACT

A waterproof bedspread includes an outer peripheral portion for engaging onto and for securing onto a headboard and a footboard and two side frames of a hospital bed with a fastening device and for forming a recess in the waterproof bedspread, the waterproof bedspread includes one or more outlet ports for discharging a water or fluid received in the recess of the waterproof bedspread, the waterproof bedspread may include a basic layer having a number of longitudinal filaments and lateral filaments each formed by a thread having a wax outer layer. A cover layer is secured onto the basic layer and includes a number of hair members provided on top to form a hairy structure.

### BACKGROUND OF THE INVENTION

1. Field of the Invention

The present invention relates to a waterproof bedspread including a cloth inner or basic layer and to provide an air circulating effect and to comfortably contact with users, and a cover layer secured onto the basic layer and having a PU material to form the waterproof bedspread and to prevent the PU material or the rubber or chemical or artificial outer layer from being directly contacting with users.

2. Description of the Prior Art

Typical bed sheets or bedspreads are required to be attached or engaged onto the mattresses of the sick beds or hospital beds for engaging with the patients.

The bed sheets or bedspreads are normally made of woven or non-woven cloth materials and may absorb water or fluid, such that the nurses may not wash or clean the patients on the sick beds or hospital beds directly, and should remove the patients from the sick beds or hospital beds for washing or showering purposes, and should move the patients onto the sick beds or hospital beds again after the washing or showering operations.

However, it will be difficult to remove the patients from the sick beds or hospital beds and to move the patients onto the sick beds or hospital beds again, and thus it will be difficult to wash or clean the patients.

The present invention has arisen to mitigate and/or obviate the afore-described disadvantages of the conventional waterproof bedspread products.

### SUMMARY OF THE INVENTION

The primary objective of the present invention is to provide a waterproof bedspread including a cloth inner or basic layer and to provide an air circulating effect and to comfortably contact with users, and a cover layer secured onto the basic layer and having a PU material to form the waterproof bedspread and to prevent the PU material or the rubber or chemical or artificial outer layer from being directly contacting with users.

In accordance with one aspect of the invention, there is provided a waterproof bedspread comprising an outer peripheral portion for engaging onto a headboard and a footboard and two side frames of a hospital bed and for forming a recess in the waterproof bedspread, the waterproof bedspread includes a fastening device attached to the outer peripheral portion of the waterproof bedspread for securing the outer peripheral portion of the waterproof bedspread onto the headboard and the footboard and the side frames of the hospital bed, and the waterproof bedspread includes at least one outlet port for discharging a water or fluid received in the recess of the waterproof bedspread.

The waterproof bedspread includes a basic layer having a plurality of longitudinal filaments and a plurality of lateral filaments coupled to the longitudinal filaments, the longitudinal and the lateral filaments are formed by a thread, a cover layer secured onto the basic layer and having a plurality of hair members provided on top thereof to form a hairy structure, and a PU material engaged and applied onto the hair members of the cover layer to form the waterproof bedspread.

The waterproof bedspread includes a wax outer layer applied on the thread, and the wax outer layer is removed from the basic layer after the PU material has been engaged onto the cover layer, to provide an air circulating effect to the basic layer.

The hose is coupled to the outlet port for water discharging purposes. A control valve may further be provided and attached to the hose. The hose may be directed to a container.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a waterproof bedspread in accordance with the present invention for attaching or engaging onto the sick bed or hospital bed;

FIG. 2 is another perspective view of the waterproof bedspread for attaching or engaging onto the sick bed or hospital bed;

FIG. 3 is a perspective view of the sick bed or hospital bed;

FIG. 4 is a side plan schematic view of the sick bed or hospital bed;

FIG. 5 is a partial exploded view of the waterproof bedspread;

FIG. 6 is an enlarged partial perspective view illustrating a stitching or coupling operation for forming or manufacturing the basic fabric layer of the waterproof bedspread;

FIG. 7 is an enlarged exploded view of the waterproof bedspread;

FIG. 8 is a perspective view illustrating a portion of the waterproof bedspread;

FIG. 9 is an enlarged partial cross sectional view taken along lines 9-9 of FIG. 8;

FIG. 10 is an enlarged partial cross sectional views similar to FIG. 9, illustrating the manufacturing process of the waterproof bedspread; and

FIG. 11 is a side plan schematic view illustrating the operation of the waterproof bedspread.

### DETAILED DESCRIPTION OF THE PREFERRED EMBODIMENT

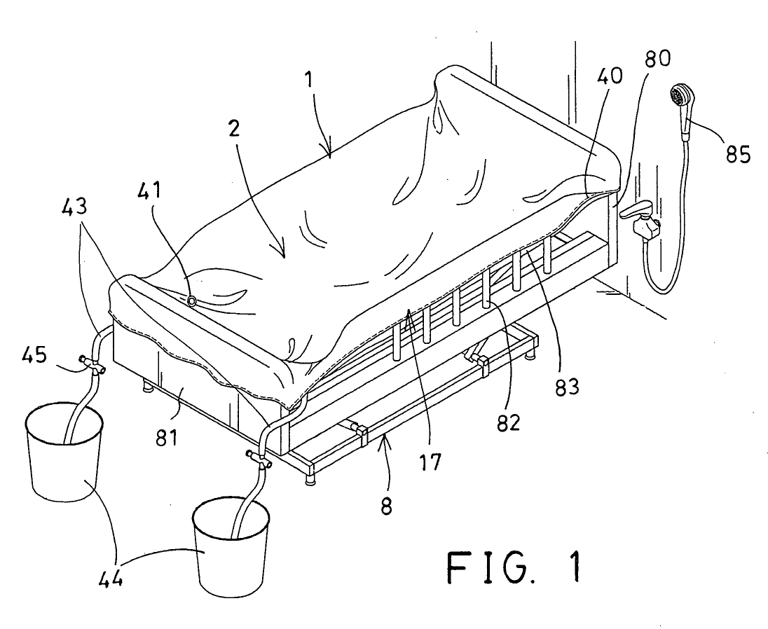

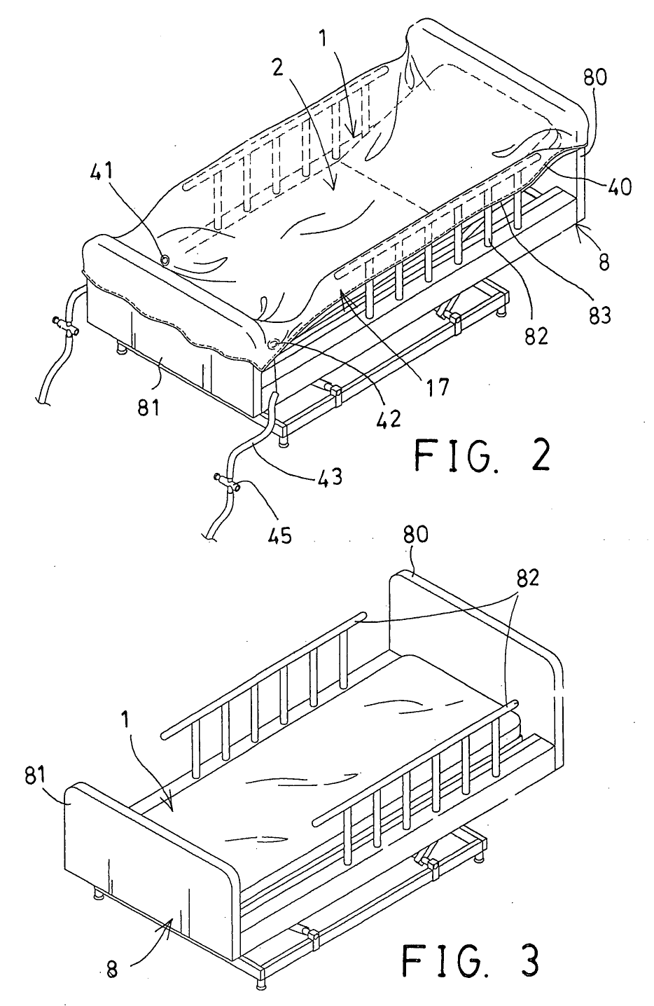

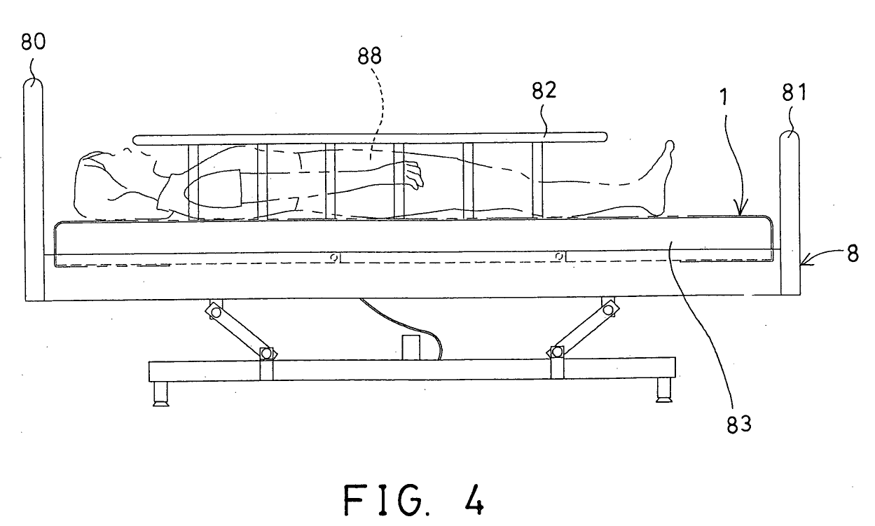

Referring to the drawings, and initially to FIGS. 1-4 and 11, a waterproof bedspread 1 in accordance with the present invention is provided for attaching or engaging onto a sick bed or hospital bed 8 which includes a headboard 80, a footboard 81, and two side frames 82, and a mattress 83 attached or engaged onto the hospital bed 8 for softly or comfortably engaging with or supporting the patients 88 (FIGS. 4, 11). The waterproof bedspread 1 may be selectively engaged onto or around the mattress 83 (FIGS. 3, 4), or engaged onto the headboard 80 and the footboard 81 and the side frames 82 (FIGS. 1, 2, 11) for forming a recess 2 (FIGS. 1, 2) and for receiving the water or fluid in the recess 2 of the waterproof bedspread 1 and for washing or showering or cleaning the patients 88 with such as a showering device 85.

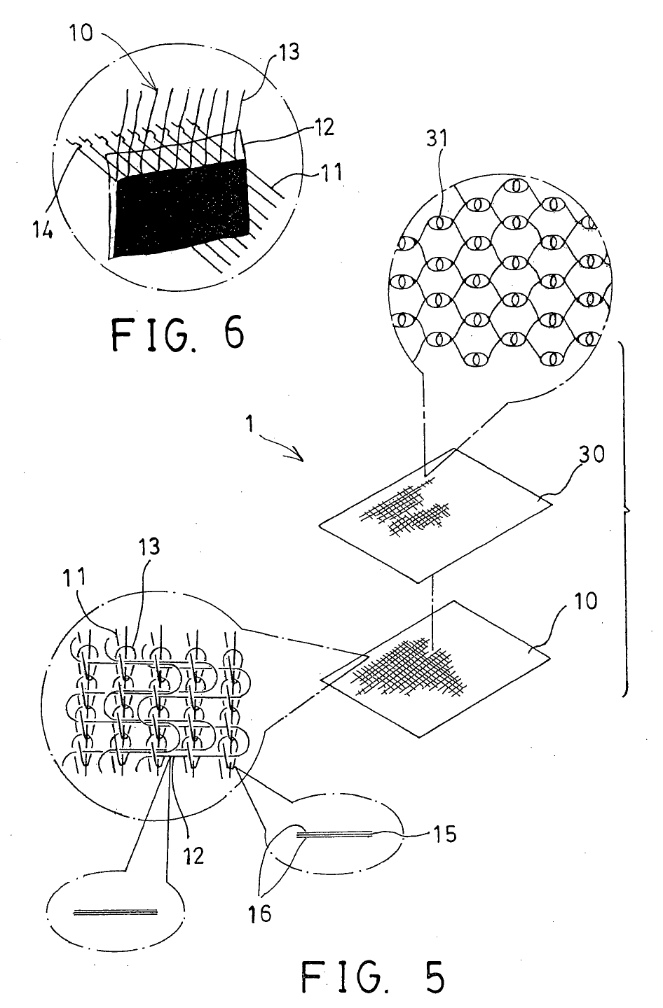

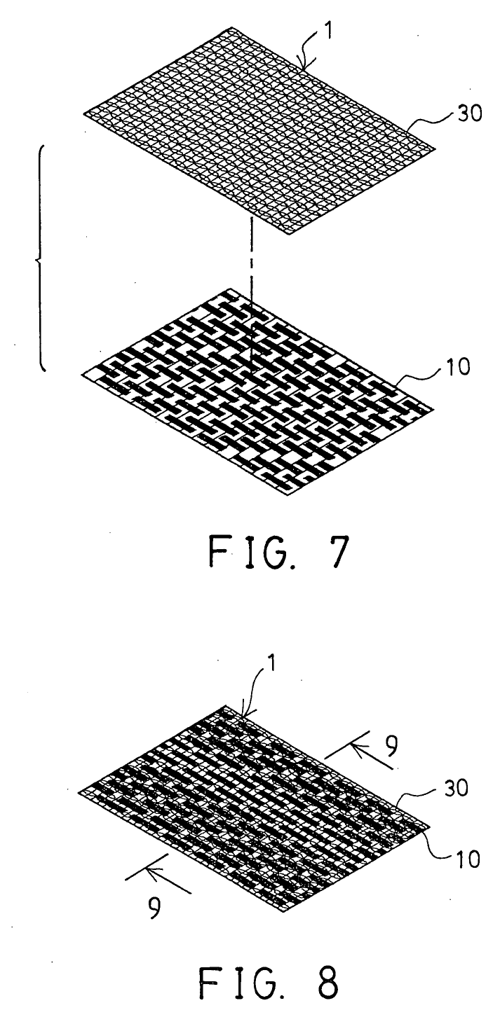

For example, as shown in FIGS. 5-8, the waterproof bedspread 1 comprises a basic layer 10, such as a basic cloth or fabric layer 10, which may be formed or made by woven or non-woven fibers or layers. For example, the basic cloth or fabric layer 10 includes a number of longitudinal filaments 11, and a number of lateral filaments 12 perpendicular to the longitudinal filaments 11, and coupled to or woven to the longitudinal filaments 11 with wound or coupling filaments 13 (FIGS. 5, 6).

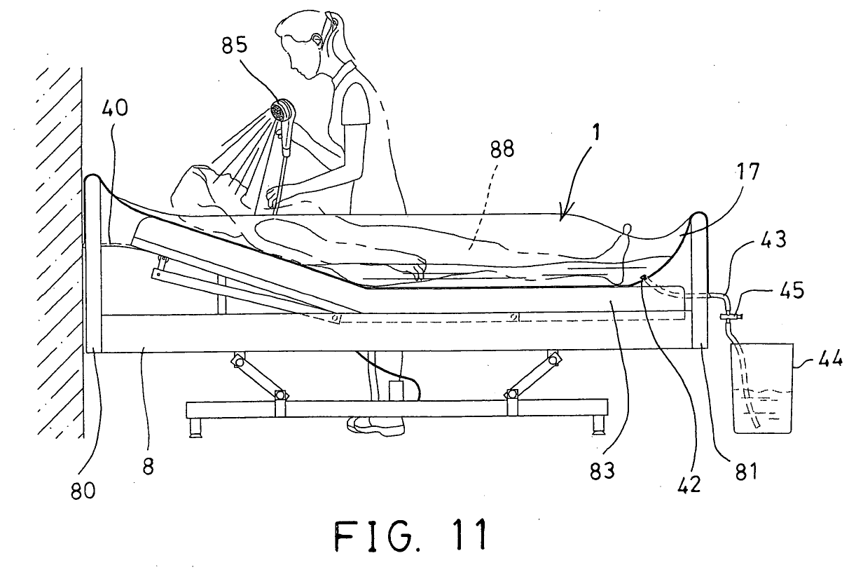

The filaments 11, 12, 13 may be formed or manufactured by warp knitting or stitching operations with needles 14 or the like, and may be formed by fibers or threads 15 (FIGS. 1, 9-10), to form a woven cloth layer having a number of perforations in the cloth inner or basic layer, for facilitating an air circulating effect to the waterproof bedspread 1. Alternatively, the filaments 11, 12, 13 may also be formed or manufactured as a nonwoven cloth layer having a number of perforations in the cloth inner or basic layer, for facilitating air circulating effect to the waterproof bedspread 1. The fibers or threads 15 may be applied thereon or covered with a wax outer layer 16 (FIGS. 5, 10), to protect the fibers or threads 15.

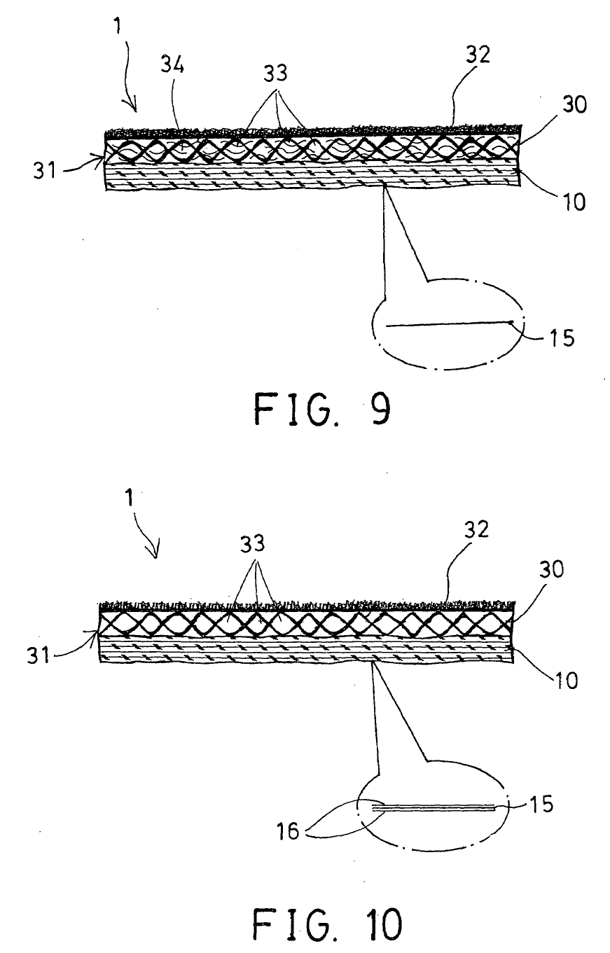

The waterproof bedspread 1 further includes a cover layer 30 or an outer cover layer 30 which may also be formed or made by woven or non-woven fibers or layers 31 (FIGS. 5, 9-10), or which may also be formed by warp knitting or stitching operations. The cover layer 30 further includes a number of fine hair members 32 formed or provided on the woven or non-woven fibers or layers 31, such as provided on top thereof, to form a hairy structure 32, best shown in FIGS. 9-10, and to form a prototype as shown in FIG. 10. The fibers or threads 15 may be applied with the wax outer layer 16 first before forming the prototype as shown in FIGS. 5, 10, or the fibers or threads 15 may first be formed into the prototype as shown in FIG. 10 and then applied the wax outer layer 16 onto the fibers or threads 15.

The cover layer 30 preferably includes a number of perforations 33 formed therein, such as formed by warp knitting or stitching operations with needles 14 or the like, for facilitating air circulating effect to the cover layer 30 of the waterproof bedspread 1. The cover layer 30 and the basic layer 10 may then be secured together by such as stitching operations, to solidly secure the cover layer 30 and the basic layer 10 together, and to allow the perforations 33 to be formed and maintained within the cover layer 30 and the basic layer 10 and for facilitating the air circulation effect to the waterproof bedspread 1.

The waterproof bedspread 1, including the basic layer 10 and the cover layer 30, is then treated with or dipped in polyurethane (PU) solutions or materials 34, as shown in FIG. 9, or has the PU materials 34 engaged onto the cover layer 30, particularly engaged onto the fibers or threads of the hair members 32 or the hairy structure 32 of the cover layer 30, to form the waterproof bedspread 1. At the moment as shown in FIG. 9, the PU materials 34 are engaged or applied onto the fibers or threads of the hair members 32 or the hairy structure 32 of the cover layer 30 only, but not completely filled within or blocked the perforations 33 of the cover layer 30, to form and to maintain the hairy structure 32 of the cover layer 30.

The cover layer 30 may then further be treated with or dipped in polyurethane (PU) solutions or materials 34, or has the PU materials 34 optionally or selectively or partially engaged into the cover layer 30, such as engaged into about one half (½) of the thickness of the cover layer 30, and then the PU materials 34 may then optionally or selectively or fully engaged into the cover layer 30, or optionally or selectively or completely engaged into the whole thickness of the cover layer 30.

It is to be noted that the fibers or threads 15 of the basic layer 10 is coated or applied or covered with the wax outer layer 16, such that the PU materials 34 will not be engaged onto or applied or covered onto the fibers or threads 15 while treating or dipping the basic layer 10 and the cover layer 30 of the waterproof bedspread 1 into the polyurethane (PU) solutions or materials 34, due to the application of the wax outer layer 16 on the fibers or threads 15 of the basic layer 10.

After the PU materials 34 have been solidly engaged onto the cover layer 30, such as engaged onto the fibers or threads of the hair members 32 or the hairy structure 32 of the cover layer 30, to form the waterproof bedspread 1, the basic layer 10 of the waterproof bedspread 1 may then be treated, such as heated, or dipped with melting solution or other chemical solutions, to melt or to remove the wax outer layer or the wax material 16 from the fibers or threads 15. The basic layer 10 will thus be provided for directly engaging onto the users, for allowing the users to feel comfortable, and to prevent the cover layer 30 and the PU materials 34 from directly contacting with the users.

It is to be noted that the provision or the applying or the covering of the wax outer layer 16 onto the fibers or threads 15 may protect the fibers or threads 15, and may prevent the fibers or threads 15 from being coated with the PU materials 34, such that the quantity of the PU materials may be decreased, and such that the waterproof bedspread 1 may include a decreased light or may include a light weight character. In addition, the cover layer 30 may also be formed by such as warp knitting or stitching operations with needles 14 or the like, to form and to provide the perforations 33 therein, and thus to facilitate the air circulating effect or the air perforation or permeating character to the cover layer 30 of the waterproof bedspread 1.

In addition, after the PU materials 34 have been solidly engaged onto the cover layer 30 to form an outer leather layer, the wax outer layer or the wax material 16 may then be removed from the fibers or threads 15 of the basic layer 10, such that the fibers or threads 15 of the basic layer 10 will be exposed and will not have the wax material 16 and the PU materials applied thereon, to allow the users to contact with the basic layer 10 that is a skin-contact layer and that is made of formed with the fibers or threads 15, and to prevent the cover layer 30 and the PU materials 34 from directly contacting with the users, and thus to allow the users to feel comfortable.

Furthermore, the wax material 16 and the PU materials may be removed and prevented from being attached or applied onto the fibers or threads 15 of the basic layer 10, such that the cloth inner or basic layer 10 may further include a decreased weight, and may also be formed with a number of perforations within the cloth inner or basic layer 10, for facilitating the air circulating effect to the waterproof bedspread 1.

As shown in FIGS. 1-2, and 11, the waterproof bedspread 1 may include a fastening device 40, such as a resilient belt or cable, a fastening rope or the like attached or engaged into the outer peripheral portion 17 of the waterproof bedspread 1 for solidly clamping or securing or retaining the outer peripheral portion 17 of the waterproof bedspread 1 onto the headboard 80 and the footboard 81 and the side frames 82 and the mattress 83 of the hospital bed 8, and for stably maintaining the recess 2 in the waterproof bedspread 1 while washing or showering or cleaning the patients 88. The waterproof bedspread 1 may include one or more outlet ports 41, 42 for discharging the water or fluid received in the recess 2 of the waterproof bedspread 1, and one or more hoses 43 coupled to the outlet ports 41, 42 for discharging the water or fluid into a container 44, and a control valve 45 attached or coupled to the hoses 43 for controlling the discharging of the water or fluid into the container 44. It is preferable that the outlet ports 41, 42 are provided at the position located closer to the footboard 81 of the hospital bed 8.

In operation, the outer peripheral portion 17 of the waterproof bedspread 1 may be directly disengaged from the outer peripheral portion of the mattress 83 and directly attached or engaged into the headboard 80 and the footboard 81 and the side frames 82 and the mattress 83 of the hospital bed 8, and for stably maintaining the recess 2 in the waterproof bedspread 1 and thus for allowing the patients 88 to be easily and readily washed or showered or cleaned without being removed form the hospital bed 8.

Accordingly, the waterproof bedspread product in accordance with the present invention includes a cloth inner or basic layer and to provide an air circulating effect and to comfortably contact with users, and a cover layer secured onto the basic layer and having a PU material to form the waterproof bedspread and to prevent the PU material or the rubber or chemical or artificial outer layer from being directly contacting with users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A waterproof bedspread comprising:
an outer peripheral portion for engaging onto a headboard and a footboard and two side frames of a hospital bed and for forming a recess in said waterproof bedspread,
said waterproof bedspread including a fastening device attached to said outer peripheral portion of said waterproof bedspread for securing said outer peripheral portion of said waterproof bedspread onto the headboard and the footboard and the side frames of the hospital bed, and
said waterproof bedspread including at least one outlet port for discharging a water or fluid received in said recess of said waterproof bedspread.

2. The waterproof bedspread as claimed in claim 1, wherein said waterproof bedspread includes a basic layer having a plurality of longitudinal filaments and a plurality of lateral filaments coupled to said longitudinal filaments, said longitudinal and said lateral filaments are formed by a thread, a cover layer secured onto said basic layer and having a plurality of hair members provided on top thereof to form a hairy structure, and a PU material engaged and applied onto said hair members of said cover layer to form said waterproof bedspread.

3. The waterproof bedspread as claimed in claim 2, wherein said waterproof bedspread includes a wax outer layer applied on said thread, and said wax outer layer is removed from said basic layer after said PU material has been engaged onto said cover layer, to provide an air circulating effect to said basic layer.

4. The waterproof bedspread as claimed in claim 1, wherein at least one hose is coupled to said at least one outlet port for water discharging purposes.

5. The waterproof bedspread as claimed in claim 4, wherein a control valve is attached to said at least one hose.

6. The waterproof bedspread as claimed in claim 1, wherein at least one hose is directed to a container.
